(19) United States
(12) Patent Application Publication
(10) Pub. No.: US 2008/0310468 A1
(43) Pub. Date: Dec. 18, 2008

(54) Laser Diode control method, laser Diode control device, and camcorder

(75) Inventor: Kenichi Nagashima, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/156,011

(22) Filed: May 28, 2008

(30) Foreign Application Priority Data
Jun. 12, 2007 (JP) 2007-155120

(51) Int. Cl. H01S 3/13; H01S 3/00

(52) U.S. Cl. 372/33; 372/38.07

(57) ABSTRACT

A laser diode is controlled such that a writing operation can be performed readily even at a low temperature and equal to or below the operation guarantee temperature range of the laser diode. A laser diode control device includes a temperature sensor for detecting temperature of a laser diode. If a detected temperature by the temperature sensor is equal to or below the operation guarantee temperature range, a current equivalent to a threshold current value is supplied to the laser diode. After a predetermined time lapses, laser light is outputted to increase temperature of the laser diode to the operation guarantee temperature thereof. Finally, a writing operation is then carried out.

### BACKGROUND OF THE INVENTION

(1) Field of the Invention

The present invention relates to a camcorder; and, more particularly, to control of a laser diode for writing information to an optical disk device used in a camcorder.

(2) Description of the Related Art

It has been long since a video camera using an optical disk device as a recording medium was produced. The optical disk device itself is now expanding its application from CD (Compact Disc) and DVD (Digital Versatile Disc) towards a next generation DVD such as HD DVD (High Definition DVD) and Blu-ray Disc (BD). The next generation DVD has a recording capacity three to five times greater than traditional DVDs, and recent advances in PDP (Plasma Display Panel) and increasing demand for high definition image has aroused a lot of interest in it as a recording medium to cope with an increase in data rate along with the high definition image.

In the optical disk device, an increase in recording capacity per unit area is one of factors of increasing the recording capacity. To accomplish this, it is necessary to make laser light irradiated onto an optical disk to record or read data smaller in diameter. The diameter of laser light can be reduced simply by using a shorter wavelength laser light for reading.

Among laser diode (LD) light sources, a blue-violet laser diode is known to output the light with the shortest wavelength. Examples of products that have an optical disk device using the blue-violet laser diode include PC (Personal Computer), game device, video recorder, and so on.

A laser beam image forming apparatus is another one that uses a laser diode. In such a device, however, if temperature of a laser diode is lower than ambient temperature, dews are sometimes formed on the output side of the laser diode and energy of the laser beam is converted into heat energy by the waterdrops, possibly breaking a lens. To prevent this, Japanese Patent Application Laid-Open Publication No. 2000-040850 or Japanese Patent Application Laid-Open Publication No. 2000-027905 suggests that if dew condensation takes place or LD temperature is lower than a preset temperature, laser beam should not be outputted until dew condensation is eliminated by feeding an offset current lower than a threshold level.

In addition, Japanese Patent Application Laid-Open Publication No. 2004-171655 describes that photographing operation of an optical disk device used for a camcorder can be assured by lowering false detection of dew condensation on a laser diode of the optical disk device.

However, a blue-violet LD has a narrower operation guarantee temperature range than LDs of different colors, and does not operate at a low temperature. Also, a low temperature kink phenomenon may occur. The low temperature kink phenomenon is observed when current-laser power linearity breaks down, given that current (horizontal axis) fed to a LD and laser light output (vertical axis) characteristics are plotted with temperature as a parameter.

These problems rarely occur when camcorders or portable BD players are used indoor, but recording (write) or reading information may not be possible if they are used in cold outdoor areas.

FIG. 1 graphically illustrates a relationship between supply current I and output laser power L (I-L characteristics) when LD temperature is 25° C. The horizontal axis represents current values (unit: mA) fed to an LD, and the vertical axis represents laser power (unit: mW) of laser light output corresponding to the current value being supplied.

In FIG. 1, Ith designates a threshold current value, and Isc designates a maximum allowable current. No laser light is outputted where the current I is smaller than the threshold current value Ith. When the threshold current value exceeds the current Ith, laser light is outputted and linearity is maintained meaning that the laser power increases proportionally to the supply current. Once the supply current reaches the maximum allowable current Isc, a laser light output saturates. That is to say, provided that the LD is within its operation guarantee temperature range, lower temperature condition makes it possible to obtain high power with a small current.

Temperature characteristics of an LD will now be described with reference to FIG. 2. FIG. 2 graphically illustrates a relationship between supply current I and output laser power L with laser temperatures (0° C., 10° C., and 20° C.) as a parameter.

As shown in FIG. 2, laser power with respect to the supply current is decreased as LD temperature is increased from 0° C. to 10° C. and 20° C. In addition, a threshold current value tends to increase as temperature is increased.

Meanwhile, when LD temperature is at 0° C., linearity disappears in mid course. The phenomenon of losing linearity at a low temperature is called a low-temperature kink. Since linearity is not present at a temperature where the low-temperature kink is observed, the temperature is outside the operation guarantee temperature range. Typically, LD would not operate at temperature outside the operation guarantee temperature range, it is impossible to perform a write (record) operation onto an optical disk device.

Japanese Patent Application Laid-Open Publication No. 2000-040850 and Japanese Patent Application Laid-Open Publication No. 2000-027905 as related art technologies concerning a laser diode drive controller provided with a cooler are to prevent an LD from being cooled to extremely low temperatures even if the LD may have become very hot by laser light output. In particular, Japanese Patent Application Laid-Open Publication No. 2000-040850 is about how to eliminate trouble in a laser drive controller caused by dew condensation, and Japanese Patent Application Laid-Open Publication No. 2000-027905 discloses a technique for driving a disk within a reference temperature range by feeding current lower than a threshold value since the temperature control is not possible at a low temperature where a cooler does not operate, thereby changing output of laser light.

According to Japanese Patent Application Laid-Open Publication No. 2004-171655, dew condensation is observed when an optical disk device built in a camcorder is cooled so that an LD therein itself becomes cooled to a temperature even lower than the ambient temperature, causing moisture in ambient atmosphere stuck to the LD. In other words, when LD temperature is higher than the operation guarantee temperature of the LD, a cooling operation is carried out compulsively. This makes only the LD temperature lower than the ambient temperature such that dew condensation problems are accompanied inevitably. This dew condensation phenomenon of Japanese Patent Application Laid-Open Publication No. 2004-171655 is also found in Japanese Patent Application Laid-Open Publication No. 2000-040850 concerning the countermeasure of dew condensation and in Japanese Patent Application Laid-Open Publication No. 2000-027905 concerning a laser diode drive controller with a cooler.

At any rate, problems in related art techniques illustrated in Japanese Patent Application Laid-Open Publications No. 2000-040850, 2000-027905, and 2004-171655 is not the same as the low-temperature kink phenomenon, i.e. a problem at a dew condensation temperature of LD or lower.

In view of the foregoing problems mentioned above, it is therefore an object of the present invention to provide a control method and device of a laser diode used for a write operation of an optical disk device employed in an apparatus, in case the laser diode is used at such a low temperature that a low temperature kink phenomenon may occur (that is, the laser diode is used for an apparatus like a camcorder and outdoors) or a surrounding temperature is lower than the operation guarantee temperature range of the laser diode, and a camcorder.

### SUMMARY OF THE INVENTION

To achieve the above object, there is provided a laser diode control method, laser diode control device, and a camcorder, wherein initial current-laser power characteristics of individual laser diode are acquired before shipping at a factory, with a predetermined temperature as a parameter, and the characteristics are stored in a memory of a camcorder or the like. Further, threshold current values at different temperatures are stored, and the laser diode temperature is monitored by the temperature sensor. Therefore, if the laser diode temperature is low, the user may issue a command to set the low-temperature write mode. In such case, a current equal to or below the threshold value at a given temperature is applied to the laser diode. During the current supply, the laser diode temperature detected by the temperature sensor is continuously monitored such that the laser diode is controlled to be supplied with a threshold current value corresponding to its present temperature.

Preferably, a threshold current value increases in accompany with an increase in temperature.

Moreover, a current value outputting a predetermined maximum power and a threshold value change over a period of years. When training mode is selected (or when power is inputted), the initial state characteristics are shifted to new ones under control.

That is, one aspect of the present invention provides a laser diode control method of a laser diode control device including a laser diode, a drive device for driving the laser diode by supplying current for laser light output, and a temperature sensor for detecting temperature around the laser diode, wherein, if temperature detected by the temperature sensor is equal to or below a predetermined value of the laser diode, current equivalent to a threshold current value of the laser diode is supplied to the laser diode, and laser light is outputted after a predetermined amount of time lapses.

Another aspect of the present invention provides a laser diode control device comprising: a laser diode; a drive device for driving the laser diode by supplying current for laser light output, the laser diode control device; a temperature sensor for detecting temperature around the laser diode; a memory for recording a threshold current value of the laser diode; and control means for supplying a threshold current corresponding to temperature to the laser diode on the basis of a temperature detected by the temperature sensor, and supplying a current for laser beam output to the laser diode after verifying that the temperature detected by the temperature sensor reached an operation guarantee temperature of the laser diode.

Preferably, the control means updates a current to be supplied to the laser diode at a predetermined interval, depending on temperature provided by the temperature sensor.

Yet another aspect of the present invention provides a camcorder, including a laser diode control device having a laser diode and a drive device for driving the laser diode by supplying current for laser light output, so as to record acquired video data onto a recording medium through the laser diode control device, the camcorder further includes: a temperature sensor for detecting temperature around the laser diode; a memory for recording a threshold current value of the laser diode; and control means for supplying a threshold current corresponding to temperature to the laser diode on the basis of the temperature detected by the temperature sensor, and supplying a current for laser beam output to the laser diode after verifying that the temperature detected by the temperature sensor reached an operation guarantee temperature of the laser diode.

Preferably, the control means of the camcorder updates a current to be supplied to the laser diode at a predetermined interval, depending on temperature provided by the temperature sensor.

The present invention makes it possible to perform a proper operation of information recording.

### BRIEF DESCRIPTION OF THE DRAWINGS

FIG. 1 illustrates one example of I-L characteristics of a laser diode (LD);

FIG. 2 illustrates one example of I-L characteristics with LD temperature as a parameter;

FIG. 3 is a block diagram illustrating the schematic configuration of a camcorder according to one embodiment of the present invention;

FIG. 4 is an exterior view of a camcorder to which the present invention is applied;

FIG. 5 is a flow chart to explain the operation procedure in a sequential order according to one embodiment of the present invention;

FIG. 6 is a flow chart to explain the operation procedure in a sequential order according to one embodiment of the present invention;

FIG. 7 shows quantitative results of temperature rise characteristics of an LD with time as a horizontal axis after feeding a current equal to or below a threshold current value to an LD;

FIG. 8 is a flow chart to explain the operation procedure in a sequential order according to one embodiment of the present invention;

FIG. 9 is a flow chart to explain the operation procedure in a sequential order according to one embodiment of the present invention;

FIG. 10 is a flow chart to explain the operation procedure in a sequential order according to one embodiment of the present invention;

FIG. 11 is a flow chart to explain the operation procedure in a sequential order according to one embodiment of the present invention; and

FIG. 12 is a diagram for explaining inequality in I-L characteristics of different LDs;

### DESCRIPTION OF THE PREFERRED EMBODIMENTS

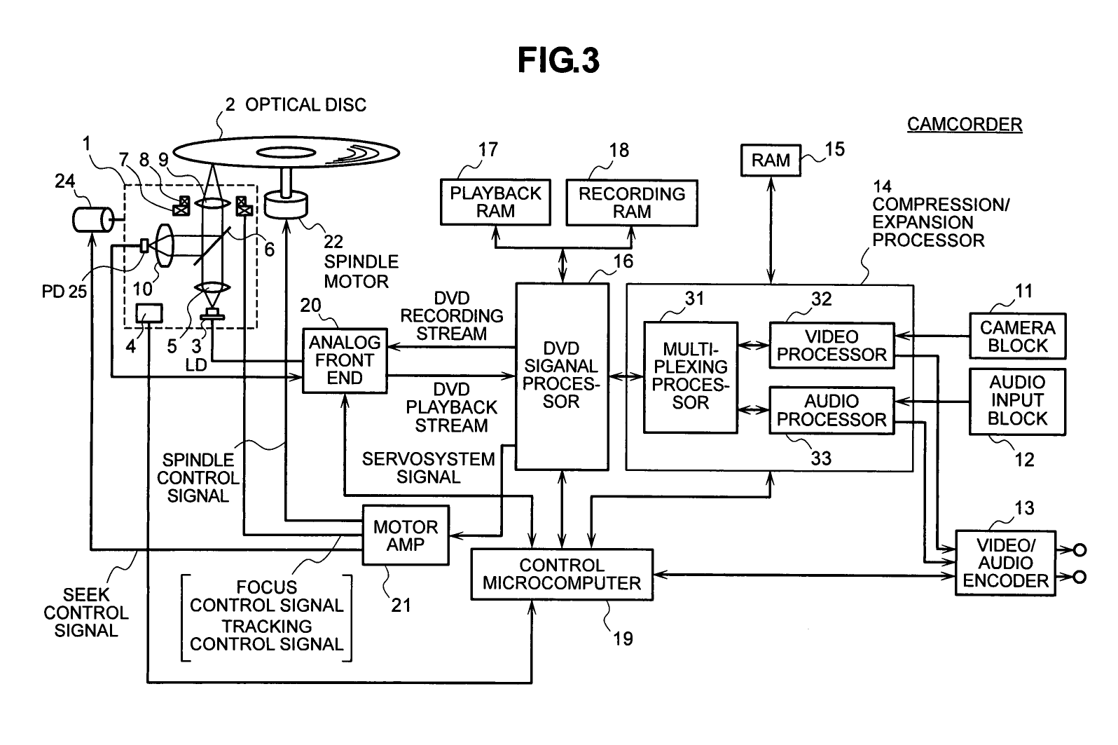

FIG. 3 is a block diagram illustrating the schematic configuration of a camcorder according to one embodiment of the present invention;

The camcorder includes an optical (pickup) head 1, an optical disk 2, a laser diode (LD) 3, a temperature sensor 4, a collimating lens 5, a beam splitter 6, a tracking actuator 7, a focus actuator 8, an objective lens 9, a condenser lens 10, a photodiode (PD) to convert light from the objective lens 10 into an electrical signal, a camera block 11, an audio input block 12, a video/audio encoder 13, a compression/expansion processing block 14, a random access memory (RAM) 15, a DVD signal processor 16, a playback RAM 17, a recording RAM 18, a control microcomputer 19, an analog front end 20, a motor AMP 21, a spindle motor 22, a seek motor 24, a multiplexer 31, a video processor 32, and an audio processor 33.

An optical disk device in the camcorder in FIG. 3 is constituted by the optical head 1 including the temperature sensor 4 and the laser diode 3, the optical disk 2, the analog front end 20, the motor AMP 21, and the seek motor 24. However, if an optical disk device is concerned, not the camcorder, the optical disk device may further include the control microcomputer 19 and part of the DVD signal processor 16 (e.g., interface). From a viewpoint of the present invention, the entire camcorder may also be involved.

Similarly, the optical disk device, the laser diode control device, or the camcorder has a unit that operates in response to a clock signal. Thus, measurement of a temporal element or decision means (to be described) will not necessarily be dealt with here.

Going back to FIG. 3, the camera block 11 includes a charge coupled device (CCD), and a drive circuit and/or a video signal processing circuit such that the CCD driven by the drive circuit converts an optical image obtained through a lens into an electrical signal and the video signal processing circuit carries out picture quality adjustment and outputs the signal to the video processor 32 of the compression/expansion processing block 14. Meanwhile, the audio input block 12 converts sound taken by a sound source sensor such as a microphone into an electrical signal and outputs the signal to the audio processor 33 of the compression/expansion processing block 14.

The video processor 32 converts an input image into a digital image signal and outputs the signal to the multiplexer 31 and the video/audio encoder 13, respectively. The audio processor 33 converts inputted sound into a digital image signal to output it to the multiplexer 31 and the video/audio encoder 13. The video/audio encoder 13 outputs input video and audio data, under the control of the microcomputer.

The multiplexer 31 multiplexes the input video data and audio data and outputs it to the DVD signal processor 16.

The DVD signal processor 16 temporarily stores the compressed video and audio data inputted from the multiplexer 31 in the recording RAM 18 and outputs a DVD recording stream to the analog front end 20. At the same time, the DVD signal processor 16 outputs a servo system signal (this is used for playback as well) to the motor AMP 21 to control a write operation on the optical disk 2. The playback RAM 17 is used for temporarily storing video and audio data that are read from the optical disk 2 and outputted from the analog front end 20 in form of a DVD playback stream during playback, and outputting the data to the multiplexer 31.

The analog front end 20 converts the DVD recording stream supplied from the DVD signal processor 16 to a current pulse and supplies it to the laser diode 3 of the optical head 1.

The laser diode 3 outputs laser light with a power level corresponding to the current value of the supplied current. The output laser light is radiated onto a recording layer of the optical disk 2 through the collimating lens 5, the beam splitter 6, and the objective lens 9 to perform a record (write) operation. At this time, the laser light emitted from the laser diode 3 is split in part by the beam splitter 6 and enters the photo diode 25 through the condenser lens 10. The photo diode 25 detects intensity of the incoming light and outputs the detected intensity data to the analog front end 20. The analog front end 20 then decides whether a current laser light power is suitable, based on the light intensity data being inputted. If so, the analog front end 20 supplies current as it is set at present. If not, however, the analog front end 20 changes a conversion rate for converting the DVD recording data stream that has been supplied from the DVD signal processor 16 to a current pulse and supplies current. Here, the analog front end 20 and the control microcomputer 19 always access data with each other and continuously update the setup conditions according to given circumstances.

The motor AMP 21 receives a servo system signal from the analog front end 20, outputs, based on the received servo system signal, a spindle control signal to the spindle motor 22; a focus control signal to the focus actuator 8; a tracking control signal to the tracking actuator 7; and a seek control signal to the seek motor 24. And the spindle motor 22 rotates the optical disk 2 in response to the spindle control signal, the tracking actuator 7 calibrates a, minute position misalignment in a radius direction (normal direction), e.g., a horizontal dithering during the rotation of the disc, in response to the tracking control signal, the focus actuator 8 adjusts the objective lens 9 in response to the focus control signal and changes a focus position of the laser light radiated onto the optical disk 2 in response to the focus tracking control signal, and the seek motor 24 changes the radiation position of the laser light to a predetermined position of the optical disk 2 in response to the seek control signal.

The temperature sensor 4 is installed in the vicinity of the laser diode 3 to detect temperature of the laser diode 3 or temperature information, and outputs the detected temperature or the temperature information to the control microcomputer 19. The control microcomputer 19 realizes or learns temperature of the laser diode 3 out of the detected temperature or the temperature information provided from the temperature sensor 4, and accesses, if necessary, to the analog front end 20 to change the conversion rate of current value to be fed to the laser diode 3 or controls the supply startup or stop.

In addition, the control microcomputer 19 not only accesses between the analog front ends 20, but also between components of the camcorder in general such that the camcorder can be kept in proper operating state.

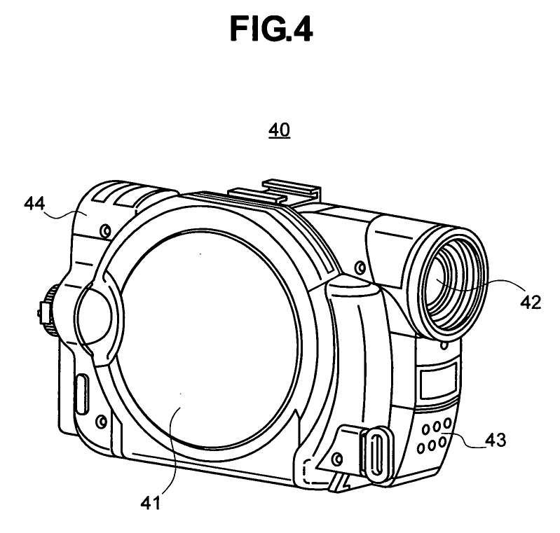

FIG. 4 is an external view of a camcorder provided as a reference. In the drawing, a camcorder 40 includes an optical disk device 41, a lens 42, a microphone 43, and a finder 44.

The optical disk device 41 is so constructed that it accepts a removable medium, such as, an optical disk (e.g., DVD-RAM), from an outside, in a detachable manner, and therefore it is susceptible to an outside atmosphere, in particular, temperature thereof.

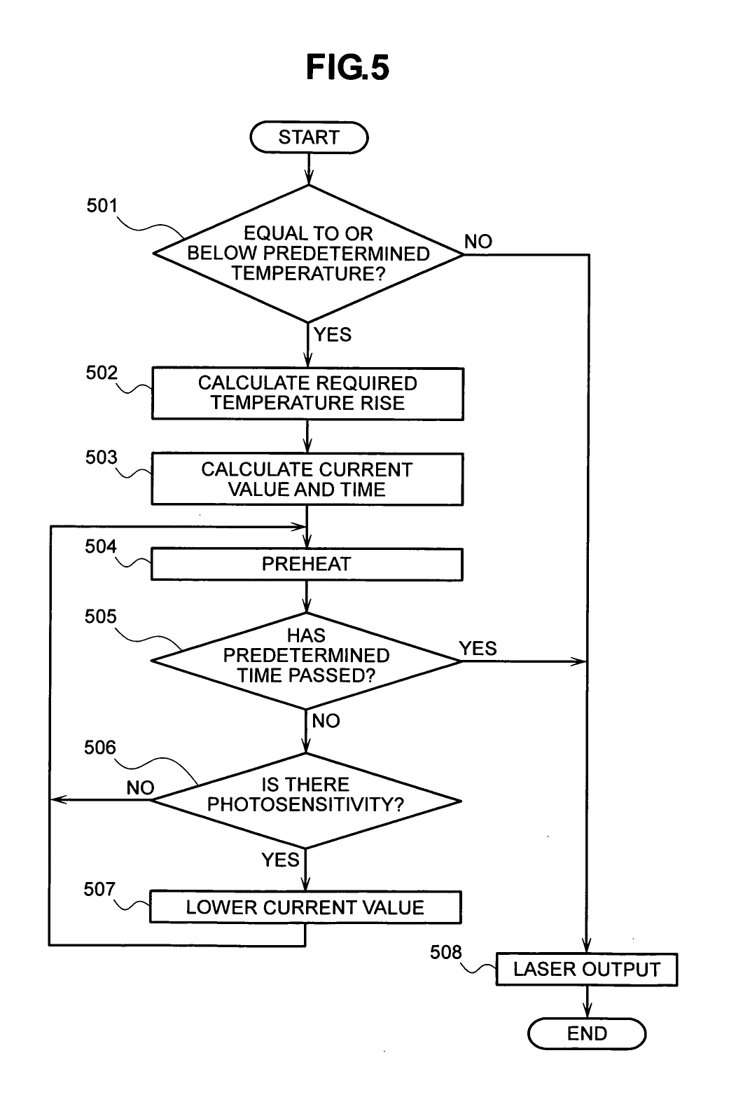

FIG. 5 explains one embodiment (Mode I) of the operation of the present invention optical disk device shown in FIG. 3. Referring to the flow chart in FIG. 5, the operation of the camcorder will now be explained in a sequential procedure.

For subsequent operations, the control microcomputer 19 accesses all necessary components inside the camcorder according to an operational program of the camcorder (e.g., taking information and executing a control). In addition, data that are required to decide, calculate or refer to an operational program are preserved in advance in a memory (not shown) in the control microcomputer 19 for example, such that the control microcomputer 19 may withdraw the data, and contents of the data are also updated according to needs. Also, the temperature sensor 4 detects temperature of the laser diode 3 at a preset time intervals that would not impede the processing operations of the control microcomputer 19 and outputs it to the control microcomputer 19. The photodiode and other detection components operate in a similar manner.

Referring to FIG. 5, when a user uses an interface such as a button and commands writing (recording) to or from a camcorder or an optical disk, the operation after step S501 starts.

First of all, in step S50 1, the control microcomputer 19 decides whether temperature of the laser diode 3 detected by the temperature sensor 4 is equal to or below the predetermined temperature. If the temperature of the laser diode 3 is equal to or below the predetermined temperature, the control microcomputer proceeds to step S502; otherwise, it proceeds to step S508.

In step S508, laser light is emitted and the typical operation where the user can write (record) to or from the camcorder or the optical disk is carried out. That is, the camcorder executes writing (recording) a photographed image onto or from a disk, e.g., DVD-RAM, which is set to the optical disk device, and ends the operation after the writing (recording) operation is performed.

In step S502, the control microcomputer 19 calculates a temperature difference between the current laser diode temperature and the predetermined temperature as a temperature rise.

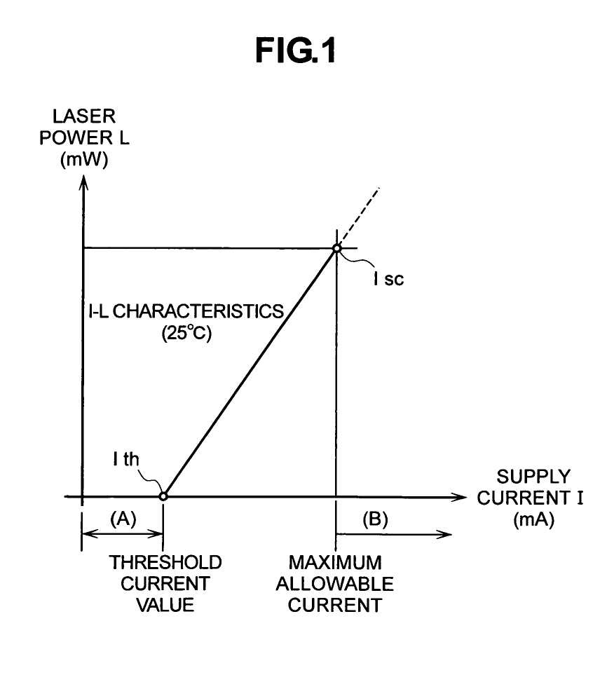

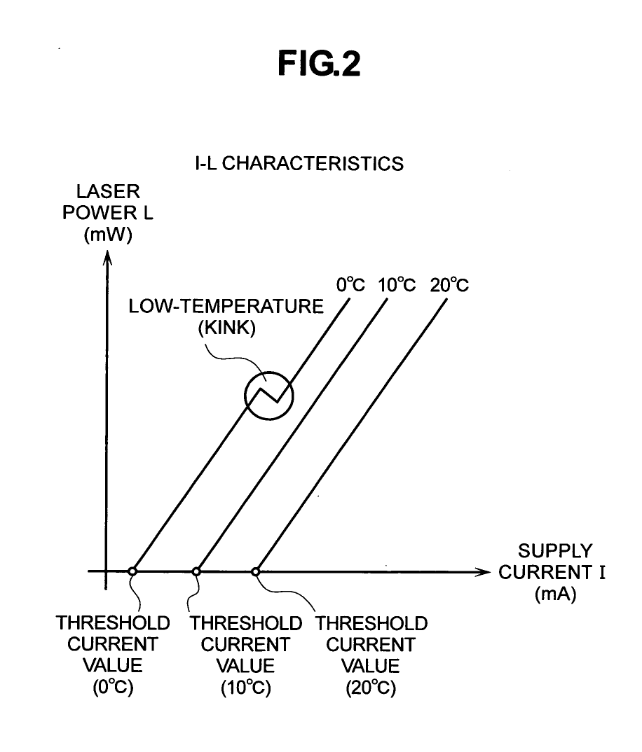

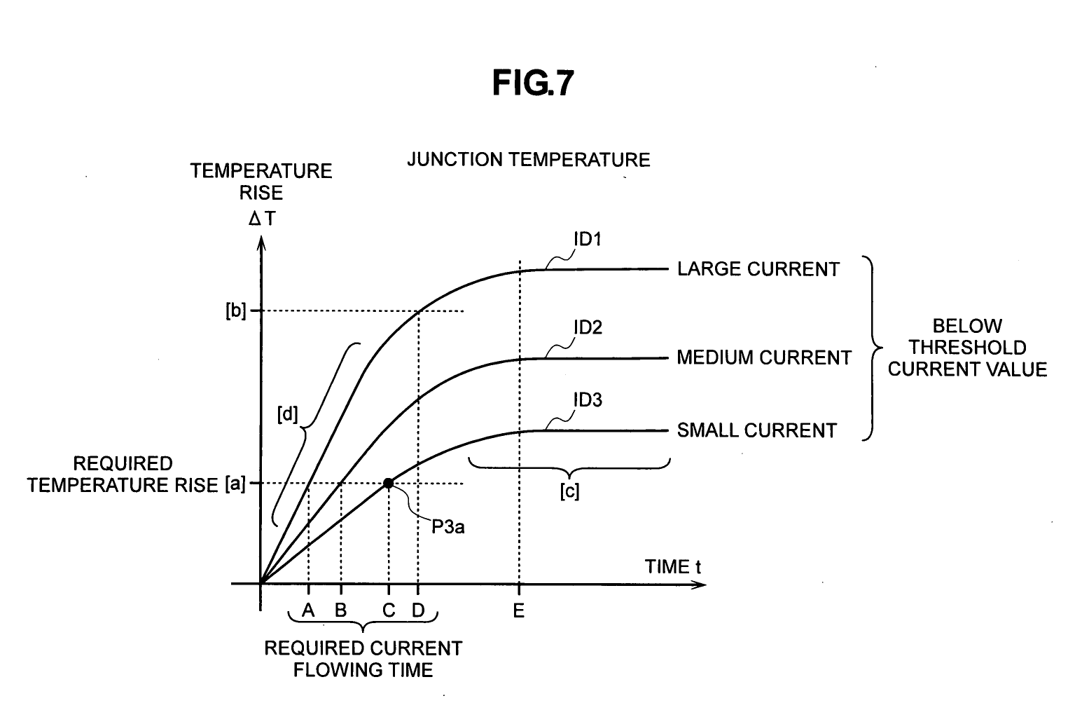

In step S503, the control microcomputer 19 acquires a maximum current value where no laser light is outputted at the present temperature (i.e. a threshold current value Ith at the detected temperature) by referring to I-L characteristic data (shown in FIG. 1 and FIG. 2), and calculates, by referring to a temperature table or using a given equation, an amount of time required to raise the temperature of the laser diode 3 as much as a required temperature rise when the threshold current value Ith was used as the supply current. And the control microcomputer 19 outputs the acquired current value to be supplied to the analog front end 20. In general, a camcorder retains data on temperature characteristics which are already measured during shipping in a built-in memory of the control microcomputer 19 for example in form of a table or an equation (to be described later in reference to FIG. 7).

In step S504, the analog front end 20 provides the current of the current value which the control microcomputer 19 has commanded to the laser diode 3 (the laser diode 3 is preheating).

In step S505, the control microcomputer 19 decides whether the calculated amount of time has elapsed. If no, it proceeds to step S506; otherwise, it stops the current supply and proceeds to step S508.

The current supply may be continued until the operation in step S508 starts.

Instead of calculating time, it is also possible to issue a command again after a preset amount of time has lapsed, by recalculating a value of the temperature sensor for a start-up.

In step S506, the control microcomputer 19 receives from the analog front end 20 a detection result of an incoming light intensity provided by the photodiode 25. If light is detected (“Yes”—whether photosensitivity is available), it proceeds to step S507; otherwise, it proceeds to step S504.

In step S507, the control microcomputer 19 issues a command for the analog front end 20 to lower the value of supplied current by a predetermined value from the present value of supplied current. And after the front end 20 lowered current value, the control microcomputer 19 proceeds to step S504.

As has been explained so far, according to the embodiment in FIG. 5, even at a low temperature outside the operation guarantee temperature range incapable of outputting laser light, a current equal to or below the threshold current value may be impressed to the laser diode to increase its temperature without outputting laser light. In so doing, the laser diode temperature gets into the operation guarantee temperature range and starts outputting laser light, such that a normal writing operation can be performed.

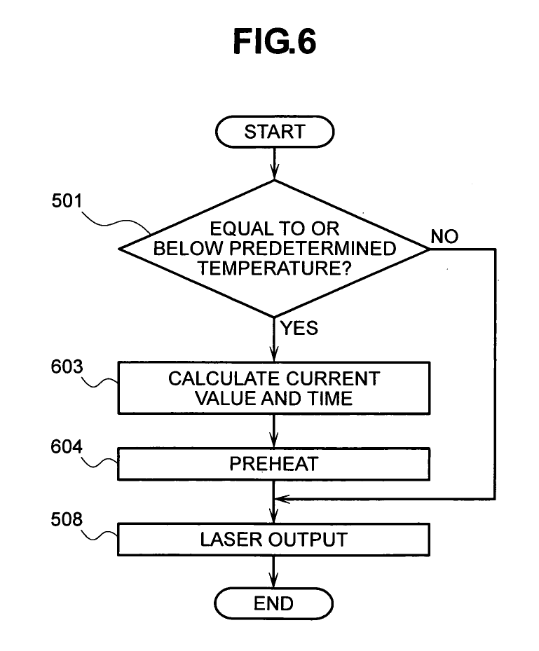

Next, the following will now describe another embodiment (Mode II) of the operation of the present invention optical disk device, with reference to FIG. 6 and FIG. 3. FIG. 6 is a flow chart for explaining the operation of the camcorder in a sequential procedure, which is more simplified than the operation in the Mode I.

For subsequent operations, the control microcomputer 19, as is done in FIG. 5, accesses all necessary components inside the camcorder according to an operational program of the camcorder (e.g., taking information and executing a control). In addition, data that are required to decide, calculate or refer to an operational program are preserved in advance in a memory (not shown) in the control microcomputer 19 for example, such that the control microcomputer 19 may withdraw the data, and contents of the data are also updated according to needs. Also, the temperature sensor 4 detects temperature of the laser diode 3 at a preset time intervals that would not impede the processing operations of the control microcomputer 19 and outputs it to the control microcomputer 19. The photodiode and other detection components operate in a similar manner.

Referring to FIG. 6, when a user uses an interface such as a button and commands writing (recording) to a camcorder or an optical disk, the operation after step S501 starts.

First of all, in step S501, the control microcomputer 19 decides whether temperature of the laser diode 3 detected by the temperature sensor 4 is equal to or below the predetermined temperature. If the temperature of the laser diode 3 is equal to or below the predetermined temperature, the control microcomputer proceeds to step S603; otherwise, it proceeds to step S508.

In step S508, the typical operation of laser light output is carried out. That is, the camcorder executes recording of a photographed image onto a disk, e.g., DVD-RAM, which is set to the optical disk device, and ends the operation after the writing (recording) operation is performed.

In step S603, as is done in the step S502 of FIG. 5, the control microcomputer 19 calculates a temperature difference between the current laser diode temperature and the predetermined temperature as a temperature rise. Moreover, the microcomputer 19 acquires a maximum current value where no laser light is outputted at the current temperature (i.e. a threshold current value Ith at the detected temperature) by referring to I-L characteristic data (shown in FIG. 1 or FIG. 2, et al.), and calculates, by referring to a temperature table or using a given equation, an amount of time necessary to raise the temperature to a required temperature when the threshold current value Ith was used as the supply current. And the control microcomputer 19 outputs the current value to be supplied and time (a preset amount of time) to the analog front end 20. In general, a camcorder retains data on temperature characteristics which are already measured during shipping in a built-in memory of the control microcomputer 19 for example in form of a table or an equation (to be described later in reference to FIG. 7).

In step S604, the analog front end 20 provides the current of the current value which the control microcomputer 19 has commanded to the laser diode 3 (the laser diode 3 is preheating). After a preset amount of time being commanded lapses, the control microcomputer 19 stops the current supply and proceeds to step S508.

The current supply may be continued until the operation in step S508 starts.

As has been explained so far, even at a low temperature outside the operation guarantee temperature range incapable of outputting laser light, a current equal to or below the threshold current value may be supplied to the laser diode to increase its temperature without outputting laser light. In so doing, the laser diode temperature gets into the operation guarantee temperature range and starts outputting laser light, such that a normal writing operation can be performed.

The following will now explain a table or an equation required for the processing operation in FIG. 5 (Mode I) or FIG. 6 (Mode II), with reference to FIG. 7. FIG. 7 is a diagram illustrating quantitative results of temperature rise characteristics of a laser diode with current supply time as a horizontal axis when a current lower than a threshold current value is fed to a laser diode.

Temperature characteristics of a laser diode used for a camcorder, an optical disk device, or a laser diode itself are acquired respectively at the time of shipping, and data on the acquired temperature characteristics are stored in a memory (e.g., a non-volatile memory built in the control microcomputer 19) inside a camcorder.

In step S503 of FIG. 5 the control microcomputer 19 obtains the supply current (equal to or below a threshold current value at a given temperature) from the I-L characteristic data. The control microcomputer 19 calculates an amount of time for reaching a temperature rise [a] having been calculated in the step s502, referring to a table based on the graph shown in FIG. 7 or using a equation.

For example, in the graph of FIG. 7, when the supply current is used small current as a parameter, it is possible to obtain time C crossing the temperature rise [a].

Step S603 in FIG. 6 is carried out similarly to the above-described steps S502 and S503.

Going back to FIG. 7, when a current equal to or below a threshold value Ith is applied to a laser diode, no laser light is outputted. Therefore, most electric energy thereof is converted to heat energy at a junction of the laser diode. Suppose that heat capacity at the junction is Tc (unit: [J/° C.], and given heat quantity is Q (unit: [J]). Then temperature rise At (unit: [° C.]) at the junction can be obtained by Equation (1) below:

Δt=Q/Tc Equation (1)

Heat quantity Q and power P (unit:[W]) satisfy a relationship expressed in Equation (2):

Q=P×t=(Id×Vd×t) Equation (2)

where, t is time (unit:[s]), Id is a supply current (unit:[A]), and Vd is a supply voltage (unit:[V]).

Substituting the Equation (1) to the Equation (2), we obtain Equation (3):

Δt=(Id×Vd×t)/Tc Equation (3)

If the supply current Id and the supply voltage Vd are constant, power P becomes constant as well. In such case, since a constant heat quantity Q is given all the time, the temperature rise At is increased proportionally to the elapsed time t (FIG. 7[d]). In reality, however, heat goes off from the junction, heat quantity Qo=a x(Tj−T0) escapes. Here, “a” is a thermal conductivity, Tj is the temperature at an junction (unit:[° C.]), and T0 is an ambient temperature (unit:[° C.]). Since heat quantity Qo being escaped is increased as the temperature at an junction is higher, a saturated state is resulted as shown in FIG. 7[c]. Also, since it takes longer time to the saturated state if a threshold current value is larger (e.g., an elapsed time D at the temperature rise [b] in FIG. 7), it becomes possible to heat the laser diode even more as a threshold current value is larger.

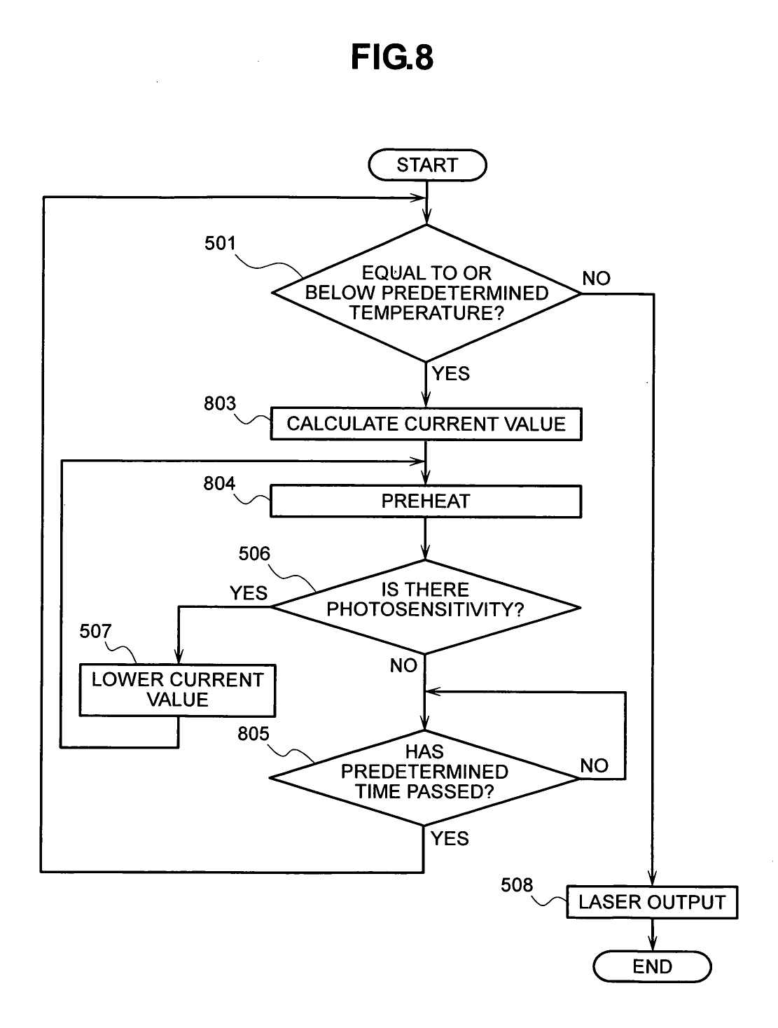

Therefore, when operations are carried out as in Mode III of FIG. 8 by modifying the sequence of operations in the flow chart of Mode I shown in FIG. 5, the method and device for current control of a laser diode and a camcorder according to the present invention can yield even better outcomes. FIG. 8 is a flow chart for explaining a sequence of operations according to one embodiment (Mode III) of the present invention.

For subsequent operations, the control microcomputer 19 accesses all necessary components inside the camcorder according to an operational program of the camcorder (e.g., taking information and executing a control). In addition, data that are required to decide, calculate or refer to an operational program are preserved in advance in a memory (not shown) in the control microcomputer 19 for example, such that the control microcomputer 19 may obtain the data, and contents of the data are also updated according to needs. Also, the temperature sensor 4 detects temperature of the laser diode 3 at a preset time intervals that would not trouble the processing operations of the control microcomputer 19 and outputs it to the control microcomputer 19. The photodiode and other detection components operate in a similar manner.

Referring to FIG. 8, when a user uses an interface such as a button and commands writing (recording) or reading (playback) to or from a camcorder or an optical disk, the operation after step S50 1 starts.

First of all, in step S501, the control microcomputer 19 decides whether temperature of the laser diode 3 detected by the temperature sensor 4 is equal to or below the predetermined temperature. If the temperature of the laser diode 3 is equal to or below the predetermined temperature, the control microcomputer proceeds to step S803; otherwise, it proceeds to step S508.

In step S508, laser light is emitted and the typical operation where the user can write (record) or read (playback) to or from the camcorder or the optical disk is carried out. That is, the camcorder records a photographed image onto a disk, e.g., DVD-RAM, which is set to the optical disk device, and ends the operation after the writing (recording) operation is performed.

In step S803, the microcomputer 19 calculates a maximum current value where no laser light is outputted at the present temperature (i.e. a threshold current value Ith at the detected temperature) by referring to I-L characteristic data (shown in FIG. 1 or FIG. 2, et al.). And the control microcomputer 19 outputs the value of current to be supplied and time (a preset amount of time) to the analog front end 20. In general, a camcorder retains data on temperature characteristics which are already measured during shipping in a built-in memory of the control microcomputer 19 for example in form of a table or a equation.

In step S804, the analog front end 20 provides the current of the current value which the control microcomputer 19 has commanded to the laser diode 3 (the laser diode 3 is preheating), and the control microcomputer 19 proceeds to step S506.

In step S506, the control microcomputer 19 receives from the analog front end 20 a detection result on the intensity of an incident light to the photodiode 25 through a condenser lens 10. If light is detected (“Yes”—whether photosensitivity is available), it proceeds to step S507; otherwise, it proceeds to step S805.

In step S507, the control microcomputer 19 issues a command for the analog front end 20 to lower the value of supplied current by a predetermined value from the present value of supplied current. And after the front end 20 lowered current value, returns to step S504.

In step S805, the control microcomputer 19 monitors whether a preheating time passed a preset amount of time. If the preset amount of time has not yet lapsed, it continues monitoring; otherwise, it returns to step S501.

In step S501, the control microcomputer 19 checks temperature of the laser diode again, which the temperature has been increased by preheating. If the laser diode temperature exceeds the predetermined temperature, the control microcomputer 19 proceeds to step S508; otherwise, it proceeds to step S803 and further, and supplies a current of a maximum current value where no laser light is outputted at the present temperature (i.e. a threshold current value Ith at the detected temperature) to the laser diode.

As such, the embodiment of FIG. 8 (Mode III) showed that a laser diode at low temperature can reach the operation guarantee temperature quickly and efficiently by monitoring the temperature of the laser diode at a predetermined cycle (interval) and always supplying a maximum current that does not output laser light to the laser diode. This enables a quick and efficient writing (recording) operation to an optical disk.

The predetermined cycle or time interval may vary according to a temperature range. For instance, a long cycle may be set if the laser diode temperature is low, while a short cycle may be set if the laser diode temperature is high. Also, if the laser diode temperature is within a high temperature range, it is possible to reduce the cycle gradually by setting the temperature range small.

As has been explained so far, even at a low temperature outside the operation guarantee temperature range incapable of outputting laser light, a current equal to or below the threshold current value may be impressed to the laser diode to increase its temperature. In so doing, the laser diode temperature gets into the operation guarantee temperature range and starts outputting laser light, such that a normal writing operation can be performed.

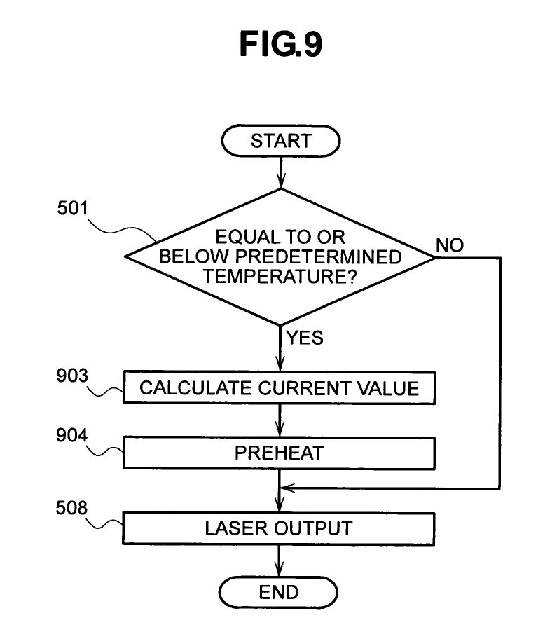

Still another embodiment (Mode IV) will now be described with reference to FIG. 9. FIG. 9 is a flow chart illustrating a sequence of operations for heating a laser diode to the operation guarantee temperature range in a simple way.

In FIG. 9, when a user uses an interface such as a button and commands writing (recording) to a camcorder or an optical disk, the operation after step S501 starts.

First of all, in step S501, the control microcomputer 19 decides whether temperature of the laser diode 3 detected by the temperature sensor 4 is equal to or below the predetermined temperature. If the temperature of the laser diode 3 is equal to or below the predetermined temperature, the control microcomputer proceeds to step S903; otherwise, it proceeds to step S508.

In step S508, the typical operation of laser light output is carried out. That is, the camcorder executes recording of a photographed image onto a disk, e.g., DVD-RAM, which is set to the optical disk device, and ends the operation after the writing (recording) operation is performed.

In step S903, the microcomputer 19 calculates a maximum current value where no laser light is outputted at the present temperature (i.e. a threshold current value Ith at the detected temperature) by referring to I-L characteristic data (shown in FIG. 1 and FIG. 2), and outputs the threshold current value Ith and time (a preset amount of time) to the analog front end 20 by referring to saturation time (time E in FIG. 7) from temperature characteristic data of FIG. 7. In general, a camcorder retains data on temperature characteristics which are already measured during shipping in a built-in memory of the control microcomputer 19 for example in form of a table or a equation.

In step S904, the analog front end 20 provides the current of the current value which the control microcomputer 19 has commanded to the laser diode 3 (the laser diode 3 is preheating), and the control microcomputer 19 proceeds to step S508.

In case of the embodiment of FIG. 9 (Mode IV), a current greater than a threshold current value Ith may be fed to the laser diode when the laser diode temperature is being raised, causing laser beam to be emitted. Therefore, a laser light radiating position should be deviated or diverted to a place irrelevant to a writing region or a reading region of the recording medium. Moreover, a focus may be put wrongly again. In step S508, the supply current is set to zero for once, and then the radiating position and the focus position go back to their original settings to start a writing operation.

As has been explained so far, even at a low temperature outside the operation guarantee temperature range incapable of outputting laser light, a current equal to or below the threshold current value may be impressed to the laser diode to increase its temperature. In so doing, the laser diode temperature gets into the operation guarantee temperature range and starts outputting laser light, such that a normal writing operation can be performed.

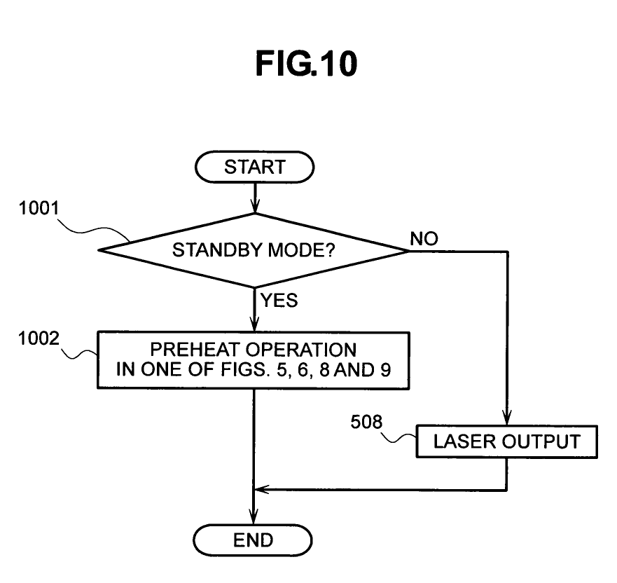

Still another embodiment of the present invention will now be described with reference to FIG. 10. In this embodiment, a camcorder or an optical disk device has an ON/OFF setup function for a low-temperature standby mode, such that when a user sets the camcorder or the optical disk device in the low-temperature standby mode, one of the embodiments described in FIG. 5, FIG. 6, FIG. 8 and FIG. 9 (one of Mode I through Mode IV) is carried out in a sequential order as indicated in the flow chart of FIG. 10.

In particular, the low-temperature standby mode is advantageous for preventing dew condensation on a laser diode. For example, when a user exchanges a removable medium in an optical disk device, an opening/closing cover for the optical disk device is opened and closed, making a laser diode therein susceptible to dew condensation. At this time, by turning off the low-temperature standby mode, dews are not formed on the laser diode and a decrease in life span of the laser diode due to damages for example can be prevented.

Another way is to set the low-temperature standby mode to be turned off automatically for a certain period of time whenever the cover of the optical disk device is either opened or closed, and let a finder to show a warning of that intention.

Referring to the embodiment of FIG. 10, when a user uses an interface such as a button and commands writing (recording) or reading (playback) to or from a camcorder or an optical disk, the operation after step S1001 starts.

In step S1001, the control microcomputer 19 decides whether the user has set the low-temperature standby mode of a camcorder or an optical disk device to ON. If the low-temperature standby mode is set to ON, the control microcomputer 19 proceeds to step S1002. If the low-temperature standby mode is set to OFF, however, the control microcomputer 19 executes a writing (recording) operation in step S508 discussed earlier with referred to FIG. 5 and others.

In step S1002, a preheating operation is carried out as is done in the embodiments of FIG. 5, FIG. 6, FIG. 8 and FIG. 9.

As has been explained so far, even at a low temperature outside the operation guarantee temperature range incapable of outputting laser light, a current equal to or below the threshold current value may be impressed to the laser diode to increase its temperature. In so doing, the laser diode temperature gets into the operation guarantee temperature range and starts outputting laser light, such that a normal writing operation can be performed.

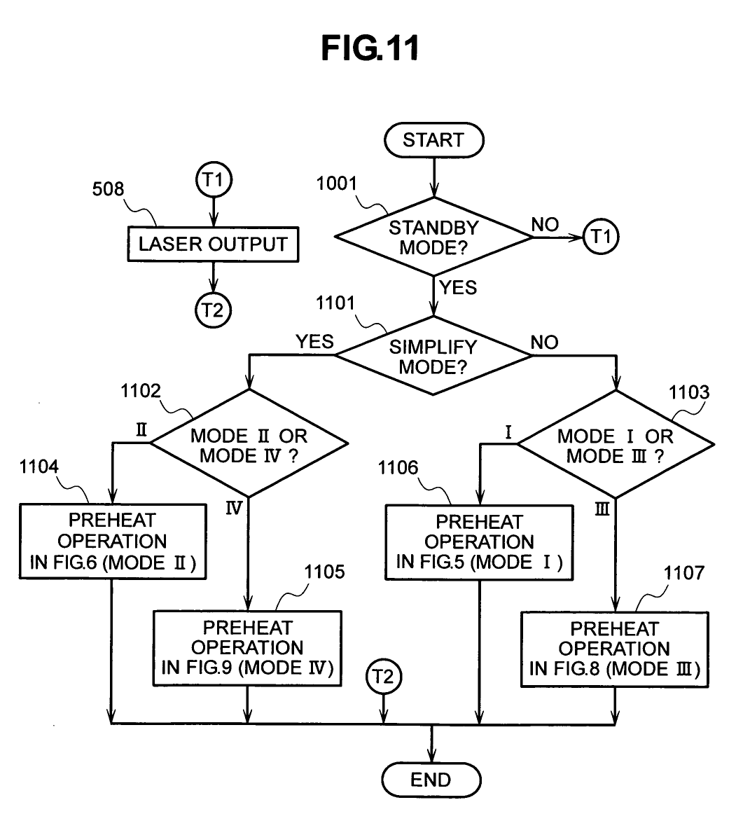

FIG. 11 describes yet another embodiment of the present invention, in which a user is allowed not only to do ON/OFF setup of the low-temperature standby mode as in the embodiment of FIG. 10, but also to select a desired kind of the low-temperature standby mode according to his or her circumstances. For example, the user may choose one of operation modes (Mode I through Mode IV) of FIG. 5, FIG. 6, FIG. 8, and FIG. 9 to be executed. With this mode, the user is now able to select a desired mode or a kind of the low-temperature standby mode according to necessity of shooting, environment conditions, conditions of electronic equipment like a camcorder, such that user convenience is greatly improved.

Referring to FIG. 11, in step S1001, the control microcomputer 19 decides whether the user has set the low-temperature standby mode of a camcorder or an optical disk device to ON. If the low-temperature standby mode is set to ON, the control microcomputer 19 proceeds to step S1101. If the low-temperature standby mode is set to OFF, however, the control microcomputer 19 executes a writing (recording) operation in step S508 discussed earlier with referred to FIG. 5 and others.

Under limited space of the drawing in FIG. 11, the step S508 is depicted separately, and the operation sequence of the step S508 (although this has already been discussed in FIG. 10) is connected in use of T1 and T2.

In step S1101, the control microcomputer 19 decides whether a simple mode (automatic mode) is set by a user. If the simple mode is set, it proceeds to step SI 102; otherwise, it proceeds to step S1103.

In step S1102, the control microcomputer 19 decides whether Mode II (shown in FIG. 6) or Mode IV (shown in FIG. 9) is set as the operation mode by a user. If Mode II is set, it proceeds to step S1104; if Mode IV is set, it proceeds to step S1105.

In step S1103, the control microcomputer 19 decides whether Mode I (shown in FIG. 5) or Mode III (shown in FIG. 8) is set as the operation mode by a user. If Mode I is set, it proceeds to step S1106; if Mode III is set, it proceeds to step S1107.

In step S1104, the sequence of operations for Mode II (shown in FIG. 6) are carried out.

In step S1105, the sequence of operations for Mode IV (shown in FIG. 9) are carried out.

In step S1106, the sequence of operations for Mode I (shown in FIG. 5) are carried out.

In step S1107, the sequence of operations for Mode III (shown in FIG. 8) are carried out.

As has been explained so far, even at a low temperature outside the operation guarantee temperature range incapable of outputting laser light, a current equal to or below the threshold current value may be impressed to the laser diode to increase its temperature. In so doing, the laser diode temperature gets into the operation guarantee temperature range and starts outputting laser light, such that a normal writing operation can be performed.

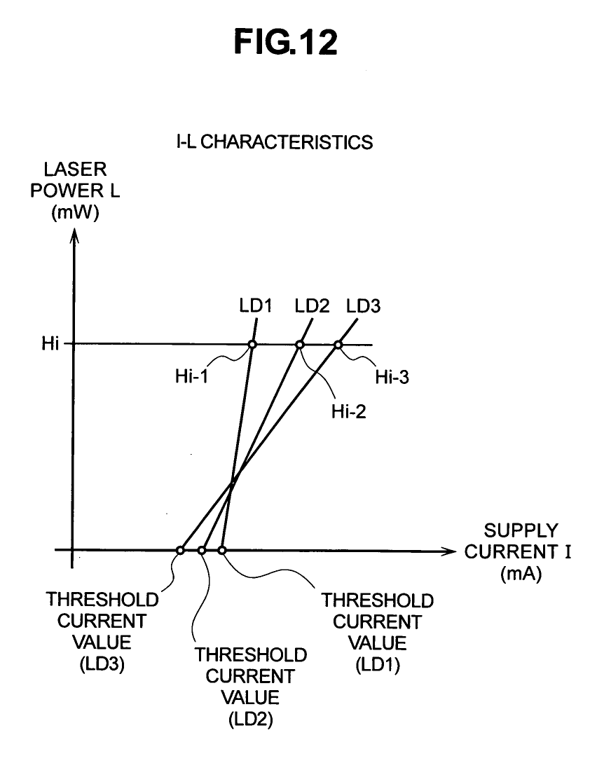

The following will now describe still another embodiment of the present invention with reference to FIG. 12, FIG. 1, FIG. 2, and FIG. 4. FIG. 12 is a diagram for explaining inequality in I-L characteristics of different laser diodes.

FIG. 12 is a diagram explaining that each laser diode in FIG. 1 has its own I-L characteristics different from the others. As depicted in FIG. 12, laser diodes LD1, LD2, and LD3 show different I-L characteristics from each other. Also, these characteristics change as the years go by.

Therefore, at the time of shipment or adjustment at a factory, initial I-L characteristics of each laser diode are first measured at every predetermined temperature and at every predetermined sampling (at every predetermined current value) to collect data, and the data are stored in a memory that is built in a camcorder or an optical disk device, or in a memory that is accessible to either one in form of a table or a equation. Moreover, laser power or intensity of laser light is measured and detected with a photodiode or the like as shown in the schematic block diagram of FIG. 4 for example. Hence, the preserved data makes it possible to carry out a series of operations of the present invention.

As to the changes over a period of years, the control microcomputer 19 measures a current value Imax outputting a maximum power rate HI being set and a threshold current value Ith based on temperature of a laser diode provided by the temperature sensor when a camcorder or an optical disk is running, and substitutes the preserved data with the measured data for shift. Even though temperature setting is not mentioned here, the laser diode may be preheated up to a predetermined temperature range as in embodiments of the present invention.

The embodiment described above has explained a camcorder combined with an optical disk device. However, the present invention is not limited to, but can be applicable to a separate video camera (including a digital camera) and an optical disk device only. Further, the optical disk device of the present invention is not limited to a camera such as a camcorder, but can be applied to an electronic machine, particularly a portable electronic machine, loaded with an optical disk device as an information recording device.

For instance, the optical disk device can be incorporated into PDA, cell phones, etc.

The present invention relates to a laser diode used for writing (recording) or reading data to or from an optical disk device as a recording medium. It is not necessarily to use a CD, DVD, next-generation DVD, etc., as long as laser light is used to perform a writing operation. For instance, a magneto-optic type recording medium using magnetism for a reading operation, e.g., Magneto-Optical Disc (Mo) or Mini Disc (MD) may be used as well. Therefore, as MD has been mentioned, any recording purposes or objects can be acceptable.

Moreover, the present invention is not limited to a laser diode only, but can be applied to LEDs with the same properties. For example, it can be used advantageously for signal lights, outdoor lamps, advertisement displays such as electric signs, traffic signs, TV sets and so on.

Even though the temperature sensor detected temperature directly, the controller like the control microcomputer may detect data in a separate physical unit like thermocouple and convert it to temperature. Also, the table or the equation does not have to be expressed in terms of temperature but as data in physical unit that the temperature sensor detects.

According to the embodiments explained so far, even at a low temperature outside the operation guarantee temperature range incapable of outputting laser light, a current equal to or below the threshold current value may be impressed to the laser diode to increase its temperature. In so doing, the laser diode temperature gets into the operation guarantee temperature range and starts outputting laser light, such that a normal writing operation can be performed.

What is claimed is:

1. A laser diode control method used for a laser diode control device including a laser diode; a drive device for driving the laser diode by supplying current for laser light output, and a temperature sensor, the method comprising the steps of:
detecting temperature around the laser diode;
supplying current equivalent to a threshold current value of the laser diode to the laser diode if temperature detected by the temperature sensor is equal to or below a predetermined value of the laser diode; and
outputting laser light after a predetermined amount of time lapses.

2. A laser diode control device, comprising:
a laser diode;
a drive device for driving the laser diode by supplying current for laser light output, the laser diode control device;
a temperature sensor for detecting temperature around the laser diode;
a memory for recording a threshold current value of the laser diode; and
control means for supplying a threshold current corresponding to temperature by the driving device to the laser diode on the basis of a temperature detected by the temperature sensor, and supplying a current for laser beam output to the laser diode after verifying that the temperature detected by the temperature sensor reached an operation guarantee temperature of the laser diode.

3. The laser diode control device according to claim 2, wherein the control means updates a current to be supplied to the laser diode at a predetermined interval, depending on temperature provided by the temperature sensor.

4. A camcorder, comprising:
a laser diode control device having a laser diode and a drive device for driving the laser diode by supplying current for laser light output, so as to record acquired video data onto a recording medium through the laser diode control device, the camcorder further including:
a temperature sensor for detecting temperature around the laser diode;
a memory for recording a threshold current value of the laser diode; and
control means for supplying a threshold current corresponding to temperature by the driving device to the laser diode on the basis of a temperature detected by the temperature sensor, and supplying a current for laser beam output to the laser diode after verifying that the temperature detected by the temperature sensor reached an operation guarantee temperature of the laser diode.

5. The camcorder according to claim 4, wherein the control means updates a current to be supplied to the laser diode at a predetermined interval, depending on temperature provided by the temperature sensor.
